(19) United States
(12) Patent Application Publication
(10) Pub. No.: US 2009/0312223 A1
(43) Pub. Date: Dec. 17, 2009

(54) Method of Controlling Structure and Rheology of Low Active Liquid Cleansers by Selecting Perfume Components

(75) Inventors: Lin Yang, Woodbridge, CT (US); Chandra Shekar Palla-Venkata, Hamden, CT (US); Yuntao Thomas Hu, Orange, CT (US); Prabhjyot Singh, Stratford, CT (US); Martin Swanson Vethamuthu, Southbury, CT (US); Alexander Lips, New Canaan, CT (US); Anthony John Weir, Westport, CT (US)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 12/138,795

(22) Filed: Jun. 13, 2008

(51) Int. Cl. C11D 9/44

(52) U.S. Cl. 510/407

(57) ABSTRACT

The invention relates to method of enhancing viscosity of low active liquid cleanser by adding perfumes individual perfume components or mixtures of components.

### FIELD OF THE INVENTION

The present invention relates to low active liquid cleansers (compositions having 15% by wt. or less, preferably 12% by wt. or less, more preferably 1-10% by wt. surfactant) and to the use of perfume or fragrance in these compositions. Specifically, the invention relates to how, when specific perfume components and/or perfume oils comprising a mixture of the components (e.g., defined by molecular volume and polarity of individual components and/or percent of components in a mixture defined by classes selected in accordance with molecular volume and polarity; and which in turn defines the effect of the components or mixture on rheology/viscosity) are used in low active cleansers compositions (i.e., cleansers having 15% by wt. or less, preferably 12% by wt. or less, preferably 7% by wt. or less, more preferably 6% by wt. or less surfactant), the component and/or mixture of components can be used to help control the structure (e.g., zero shear viscosity) and rheology of the low active liquid compositions.

### BACKGROUND

The present invention relates to low active liquid cleanser in which specific perfume components (specified by molecular volume and polarity of individual components and/or mixtures with the individual components of the classes defined by classes selected in accordance with molecular volume and polarity, and mixtures defined by % of each class within the mixture) are used to control the structure and/or rheology of the typically low viscosity liquids.

Typically, structure is regulated/defined by factors which include, for example, surfactant concentration and structuring or thickening polymers (both of which help increase standing viscosity.) However, in compositions with low surfactant concentration (e.g., 12% or less by wt. of formulation) and in which use of polymer may be constrained (for cost reasons, for example), it would be tremendously advantageous to find other ways to regulate viscosity. Unexpectedly and unpredictably, applicants have found that the selection of perfume components and/or mixtures of these components can achieve precisely this goal.

It is known that, based on the type of fragrance compound used, the compound will locate itself in different parts of a surfactant monomer or micelle. Several journal articles, for example, relate to the location of fragrance compounds in relation to structures (e.g., micelles, phases formed from micelles such as lamellar or hexagonal phases) found in solutions. These articles include the following:
Kayali Ibrahim, Khawla Qamhieh, Bjorn Lindman (Physical Chemistry, Lund University, Sweden) “Effect of Type of Fragrance Compounds on Their Location in Hexagonal Liquid Crystal” Journal of Dispersion Science and Technology, Vol. 27, 1151, 2006.
Monzer Fanun, Wail Salah Al-Diyn, “Structural Transitions in the System Water/Mixed Nonionic Surfactants/R (+) Limonene Studied by Electrical Conductivity and Self-Diffusion-NMR” Journal of Dispersion Science and Technology, 28: 165-174, 2007.
Samuel A. Vona, Stig E. Friberg, Andre-Jean Brin, “Location of Fragrance Molecules within Lamellar Liquid Crystals” Colloids and Surfaces A: Physicochemical and Engineering Aspects, 137, 79, 1998

These references relate to where perfumes will locate and none of these references disclose or suggest that the fragrances and/or components of the fragrances can be specifically selected for use in specifically low active liquid compositions to, for example, enhance viscosity of the compositions.

There are also a number of references relating to use of hydrotropes (compounds which increase the solubility in water of otherwise insoluble compounds) on rheological behavior of surfactant solutions (see, for example, Varade et al. “Effect of Hydrotropes on the Aqueous Solution Behavior of Surfactants” Journal of Surfactants and Detergents, vol. 7, No. 3, 257, 2004).

Again, this has nothing to do with use of perfumes to modify structure (e.g., enhance viscosity), particularly in low active surfactant systems.

### BRIEF SUMMARY OF THE INVENTION

Unexpectedly, applicants have now found that perfume components themselves (and/or perfume compounds comprising mixtures of the components) can be used to help structure compositions, specifically low active liquid cleanser compositions. More specifically, when components are selected in defined manner (e.g., by molecular volume, polarity), they can be used to control the structure (e.g., viscosity) and/or rheology of the low active compositions.

The invention relates to low active (i.e., 15% by wt. or less, preferably 12% by wt. or less, more preferably 1 to 10% by wt.) liquid cleanser compositions comprising either individual perfume components where the component has molecular volume V (where V length times width times depth of molecule)>400 A³ and polarity (calculated using molecular modeling software)>1 MPa^{1/2}. Alternatively, the composition has a mixture of components wherein >50%, preferably >60% of components which comprise the perfume mixture have a molecular volume V>400 A³ and polarity >1 MPa^{1/2}. In particular, the invention relates to a method of enhancing viscosity of low surfactant compositions (containing no perfume) having a viscosity <1 to a viscosity >25 Pa·s (at zero shear), preferably >40, more preferably >50, more preferably >60 to 500 Pa·s, which method comprises mixing component or mixture of components as defined above into said low surfactant compositions.

In a second embodiment of the invention, the invention relates to a method of enhancing viscosity of low active liquid cleansers containing no perfume and having viscosity <1 Pa·s to a viscosity of >1 to 40 Pa·s which method comprises mixing component having a molecular V<400 A³ and polarity >1 MPa^{1/2} (or mixture of components as defined wherein >50% preferably >60% of components meet this definition) into low surfactant compositions.

These and other aspects, features and advantages will become apparent to those of ordinary skill in the art from a reading of the following detailed description and the appended claims. For the avoidance of doubt, any feature of one aspect of the present invention may be utilized in any other aspect of the invention. It is noted that the examples given in the description below are intended to clarify the invention and are not intended to limit the invention to those examples per se. Other than in the experimental examples, or where otherwise indicated, all numbers expressing quantities of ingredients or reaction conditions used herein are to be understood as modified in all instances by the term “about”. Similarly, all percentages are weight/weight percentages of the total composition unless otherwise indicated. Numerical ranges expressed in the format “from x to y” are understood to include x and y. When for a specific feature multiple preferred ranges are described in the format “from x to y”, it is understood that all ranges combining the different endpoints are also contemplated. Where the term “comprising” is used in the specification or claims, it is not intended to exclude any terms, steps or features not specifically recited. All temperatures are in degrees Celsius (° C.) unless specified otherwise. All measurements are in SI units unless specified otherwise. All documents cited are—in relevant part—incorporated herein by reference.

### BRIEF DESCRIPTION OF THE FIGURES

FIG. 1 shows how steady shear viscosity is effected by the particular perfume component chosen. In particular, it is seen how lilial and linalool (having molecular volume >400 A³ and polarity >1 MPa^{1/2}) significantly enhance viscosity (before addition viscosity was <1 Pa·s).

### DETAILED DESCRIPTION OF INVENTION

The invention is directed to low active liquid compositions comprising specifically selected perfume components and/or mixtures of these components. Specifically, it is directed to a method of enhancing rheology of low active cleansers (relative to their zero shear or “standing” viscosity in the absence of perfume) by selecting specific perfume components and/or mixtures of components (based on molecular volume and polarity considerations). Depending on class of perfume(s) chosen, viscosity enhancement can vary from <1 to >25 up to 500 Pa·s, (“large” enhancement); to from <1 to >1 to 40 Pa·s (intermediate enhancement).

The invention is described in more detail as set forth below:

### Low Active Liquids

The compositions of the invention are cleansing compositions having 0.1-15%, preferably 0.5-12%, preferably 1-10%, more preferably 8% by wt. or less and even more preferably 6% by wt. or less of surfactant(s) selected from the group consisting of anionic, nonionic, amphoteric, cationic surfactants and mixtures thereof.

The anionic detergent active which may be used may be aliphatic sulfonated, such as a primary alkanet (e.g., C₈-C₂₂) sulfonated, primary alkanet (e.g., C₈-C₂₂) dislocate, C₈-C₂₂ alkenes sulfonated, C₈-C₂₂ hydroxyalkane sulfonate or alkyl glyceryl ether sulfonate (AGS); or aromatic sulfonates such as alkyl benzene sulfonate.

The anionic may also be an alkyl sulfate (e.g., C₁₂-C₁₈ alkyl sulfate) or alkyl ether sulfate (including alkyl glyceryl ether sulfates). Among the alkyl ether sulfates are those having the formula:

RO(CH₂CH₂O)ₙSO₃M
wherein R is an alkyl or alkenyl having 8 to 18 carbons, preferably 12 to 18 carbons, n has an average value of greater than 1.0, preferably greater than 3; and M is a solubilizing cation such as sodium, potassium, ammonium or substituted ammonium. Ammonium and sodium lauryl ether sulfates are preferred.

The anionic may also be alkyl sulfosuccinates (including mono- and dialkyl, e.g., C₆-C₂₂ sulfosuccinates); alkyl and acyl taurates, alkyl and acyl sarcosinates, sulfoacetates, C₈-C₂₂ alkyl phosphates and phosphates, alkyl phosphate esters and alkoxyl alkyl phosphate esters, acyl lactates, C₈-C₂₂ monoalkyl succinates and maleates, sulphoacetates, alkyl glucosides and acyl isethionates, and the like.

Sulfosuccinates may be monoalkyl sulfosuccinates having the formula:

R⁴O₂CCH₂CH(SO₃M)CO₂M; and
amide-MEA sulfosuccinates of the formula;

R⁴CONHCH₂CH₂O₂CCH₂CH(SO₃M)CO₂M
wherein R⁴ ranges from C₈-C₂₂ alkyl and M is a solubilizing cation.

Sarcosinates are generally indicated by the formula:

R¹CON(CH₃)CH₂CO₂M,
wherein R¹ ranges from C₈-C₂₀ alkyl and M is a solubilizing cation.

Taurates are generally identified by formula:

R²CONR³CH₂CH₂SO₃M
wherein R² ranges from C₈-C₂₀ alkyl, R³ ranges from C₁-C₄ alkyl and M is a solubilizing cation.

The inventive cleansing composition may contain C₈-C₁₈ acyl isethionates. These esters are prepared by reaction between alkali metal isethionate with mixed aliphatic fatty acids having from 6 to 18 carbon atoms and an iodine value of less than 20. At least 75% of the mixed fatty acids have from 12 to 18 carbon atoms and up to 25% have from 6 to 10 carbon atoms.

One or more amphoteric surfactants may be used in this invention. Amphoteric surfactants are preferably used at levels as low as about 0.5 or 0.8, and at levels as high as about 4 or 5% by wt. Such surfactants include at least one acid group. This may be a carboxylic or a sulphonic acid group. They include quaternary nitrogen and therefore are quaternary amido acids. They should generally include an alkyl or alkenyl group of 7 to 18 carbon atoms. They will usually comply with an overall structural formula:

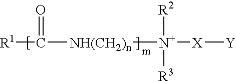

where R¹ is alkyl or alkenyl of 7 to 18 carbon atoms;
R² and R³ are each independently alkyl, hydroxyalkyl or carboxyalkyl of 1 to 3 carbon atoms;
   n is 2 to 4;
   m is 0 to 1;
X is alkylene of 1 to 3 carbon atoms optionally substituted with hydroxyl, and
   Y is —CO₂— or —SO₃—

Suitable amphoteric surfactants within the above general formula include simple betaines of formula:

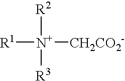

and amido betaines of formula:

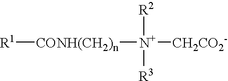

where n is 2 or 3.

In both formulae R¹, R² and R³ are as defined previously. R¹ may in particular be a mixture of C₁₂ and C₁₄ alkyl groups derived from coconut oil so that at least half, preferably at least three quarters of the groups R¹ have 10 to 14 carbon atoms. R² and R³ are preferably methyl.

A further possibility is that the amphoteric detergent is a sulphobetaine.

Amphoacetates and diamphoacetates are also intended to be covered in possible zwitterionic and/or amphoteric compounds which may be used such as e.g., sodium lauroamphoacetate, sodium cocoamphoacetate, and blends thereof, and the like.

One or more nonionic surfactants may also be used in the cleansing composition of the present invention. Nonionic surfactants are preferably used at levels as low as about 0.5 or 0.8 and at levels as high as about 1.5 or 2% by wt.

The nonionics which may be used include in particular the reaction products of compounds having a hydrophobic group and a reactive hydrogen atom, for example aliphatic alcohols, acids, amides or alkylphenols with alkylene oxides, especially ethylene oxide either alone or with propylene oxide. Specific nonionic detergent compounds are alkyl (C₆-C₂₂) phenols ethylene oxide condensates, the condensation products of aliphatic (C₈-C₁₈) primary or secondary linear or branched alcohols with ethylene oxide, and products made by condensation of ethylene oxide with the reaction products of propylene oxide and ethylenediamine. Other so-called nonionic detergent compounds include long chain tertiary amine oxides, long chain tertiary phosphine oxides and dialkyl sulphoxide, and the like.

The nonionic may also be a sugar amide, such as a polysaccharide amide. Specifically, the surfactant may be one of the lactobionamides described in U.S. Pat. No. 5,389,279 to Au et al. titled “Compositions Comprising Nonionic Glycolipid Surfactants issued Feb. 14, 1995; which is hereby incorporated by reference or it may be one of the sugar amides described in U.S. Pat. No. 5,009,814 to Kelkenberg, titled “Use of N-Poly Hydroxyalkyl Fatty Acid Amides as Thickening Agents for Liquid Aqueous Surfactant Systems” issued Apr. 23, 1991; hereby incorporated into the subject application by reference.

One or more cationic surfactants may also be used in the cleansing composition. Cationic surfactants may be used at levels as low as about 0.1, 0.3, 0.5 or 1 and at levels as high as 2, 3, 4 or 5% by wt.

Examples of cationic detergents are the quaternary ammonium compounds such as alkyldimethylammonium halogenides.

Other suitable surfactants which may be used are described in U.S. Pat. No. 3,723,325 to Parran Jr. titled “Detergent Compositions Containing Particle Deposition Enhancing Agents” issued Mar. 27, 1973; and “Surface Active Agents and Detergents” (Vol. I & II) by Schwartz, Perry & Berch, both of which are also incorporated into the subject application by reference.

In a preferred embodiment of the invention, the surfactant system may comprise a blend of alkali metal or ammoniumalkyl (e.g., lauryl) sulfate (e.g., at about 3-10% by wt.) and alkylamidopropylbetaine (e.g., at about 1-5% by wt.), the total blend comprising, 15% by wt. or less, preferably 12% by wt. or less of the composition.

Compositions of the invention typically possess isotropic micellar phase microstructure. In general, the rheological behavior of all surfactant solutions, including liquid cleansing solutions, is strongly dependent on the microstructure, i.e., the shape and concentration of micelles or other self-assembled structures in solution.

When there is sufficient surfactant to form micelles (concentrations above the critical micelle concentration or CMC), for example, spherical, cylindrical (rod-like or discoidal), spherocylindrical, or ellipsoidal micelles may form. As surfactant concentration increases, ordered liquid crystalline phases such as lamellar phase, hexagonal phase, cubic phase or L3 sponge phase may form. The non-isotropic hexagonal phase, consists of long cylindrical micelles arranged in a hexagonal lattice. In general, the microstructure of most personal care products consist of either an isotropic dispersion including spherical micelles; and rod micelles; or an ordered liquid crystalline phase such as a lamellar dispersion.

As noted above, micelles may be spherical or rod-like. Formulations having spherical micelles tend to have a low viscosity and exhibit Newtonian shear behavior (i.e., viscosity stays constant as a function of shear rate); thus, if easy pouring of product is desired, the solution is less viscous. In these systems, the viscosity increases linearly with surfactant concentration.

Rod micellar solutions tend to be more viscous because movement of the longer micelles is restricted. At a critical shear rate, the micelles align and the solution becomes shear thinning. Addition of salts increases the size of the rod micelles thereof increasing zero shear viscosity (i.e., viscosity when sitting in bottle) which helps suspend particles but also increases critical shear rate (point at which product becomes shear thinning; higher critical shear rates means that the product is more difficult to pour).

Lamellar dispersions differ from both spherical and rod-like micelles because they can have high zero shear viscosity (because of the close packed arrangement of constituent lamellar droplets), yet these solutions are very shear thinning (readily dispense on pouring). That is, the solutions can become thinner than rod micellar solutions at moderate shear rates.

In formulating liquid cleansing compositions, therefore, there is the choice of using isotropic micellar phases such as rod-micellar solutions; or lamellar dispersions. When rod-micellar solutions are used, they also often require the use of external structurants to enhance viscosity and to suspend particles. For this, carbomers and clays are often used. At higher shear rates (as in product dispensing, application of product to body, or rubbing with hands), since the rod-micellar solutions are less shear thinning, the viscosity of the solution stays high and the product can be stringy and thick.

One way of characterizing the micellar dispersions (of the invention) includes cone and plate viscosity measurement as described below. The inventive isotropic composition has a viscosity in the range of about 1 to about 300 Pascal·sec (pa·s) @ 0.01 sec⁻¹ shear rate at 25° C., as measured by a cone and plate technique described below. Preferably the viscosity is in the range of about 50 to 200 Pa·s.

In the subject invention, since there is low amount of active used, as indicated, it is difficult to enhance viscosity without use of external structurants. Surprisingly, however, applicants have discovered that perfume components/fragrances can be used to structure low active liquids. The key is to understand how the structure (defined by volume of molecule, and by polarity) of the fragrance components works so that, if fragrance component or mixture of components is properly selected, the structure and rheology (e.g., zero shear viscosity) can be controlled. In the subject invention, component or components are selected to enhance viscosity (zero shear viscosity) from below 1 Pa·s (when no perfume is present) to >1 or >25 and even up to 500 Pa·s depending on selection criteria.

### Perfumes/Perfume Components

The compositions of the invention comprise about 0.1 to 3% by wt., preferably 0.2 to 2% by wt. perfume oil. Although a single perfume composition can be used, the mixtures typically comprise two or more components. In fact, a typical oil is a mixture of about 30 to 100 compounds with different physiochemical properties.

In general, the fragrance compounds in a perfume mixture can be classified into the following groups:
(1) perfume with polar headgroup and relatively straight hydrophobic chain (polar and “slender”);
(2) perfume with a polar headgroup and a bulky hydrophobic chain (polar and bulky);
(3) perfume that is totally hydrophobic such as some of the hydrocarbon compounds (non-polar).

The perfume oils may further comprise water soluble co-solvents such as dipropylene glycol.

According to the subject invention, perfume compounds within different groups were found to affect the rheology of liquid compositions, particularly low surfactant compositions, significantly differently.

Surprisingly, applicants have discovered that polarity, derived from Hansen Solubility Parameter calculation, as well as the volume of molecule, together correlate well with the effect of individual components on the formulation's structural/rheological behavior. These quantities can therefore be used as selection criteria for perfume components.

Polarity is defined by Hansen Solubility Parameter and is calculated by the fragment constant addition. The fragment values were determined from Hansen's work. Molecular volume (V) is calculated by: V=L*W*D. where L, W and D are the length, width and depth of the molecule, respectively (*equals multiplication). Polarity, L, W, and D are calculated by a commercially available molecular modeling software such as the following: Molecular Modeling Pro Revision 3.33, published by ChemSW® inc.

See Charles M. Hansen, Chapter I, “Hansen Solubility Parameters” by CRC Press in 1999.

More specifically, in one embodiment of the invention, the invention comprises compositions with 15% or less active and wherein perfume components are selected such that molecular volume (V)>400 A³ and average polarity >1 MPa^{1/2}. When such individual component or mixture of components is used, this has been found to enhance viscosity of a low active formulation which has viscosity of <1 Pa·s (prior to perfume addition) to viscosity of >25 Pa·s (at zero shear), preferably >40, up to 500 Pa·s.

While typically >50% of components in a perfume mixture are required to see this effect, specific components may be used individually to provide the same effect. Examples of individual components which meet defined criteria are set forth in Example 1 (e.g., polysantol, alpha hexylcinnamaldehyde etc.).

In a second embodiment of the invention, the invention comprises compositions having 15% or less active and wherein perfume components are selected such that the individual perfume components, or >50% of components within a mixture of components, has/have a molecular volume (V)<400 A³ (angstroms cubed) and average polarity >1 MPa^{1/2}. Use of such component or mixture of components has been found to enhance composition of viscosity of <1 Pa·s (prior to perfume addition) to a viscosity of >1 to 40 Pa·s (at zero shear). Examples of compounds meeting the defined criteria of the second embodiment are found in Example 2.

Water comprises about 70 to 99% by wt. of the composition.

Typically, pH is about 3 to 11, preferably 4 to 10.

### Other Compositional Components

As indicated, the invention is related to use of individual perfume components or mixtures of these components to enhance viscosity of low active compositions. The compositions may comprise other optional ingredients as set forth below.

While the compositions, as noted, are preferably thickened by use of individual perfume components or mixtures of such, preferably there is present 0-3% thickening agents, more preferably less than 2%, more preferably less than 1%, more preferably less than 0.5% and more preferably absent altogether.

Suitable thickening agents which may be used include polacrylates; fumed silica natural and synthetic waxes, alkyl silicone waxes such as behenyl silicone wax; aluminum silicate; lanolin derivatives such as lanesterol; C8 to C20 fatty alcohols; polyethylene copolymers; polyammonium stearate; sucrose esters; hydrophobic clays; petrolatum; hydrotalcites; and mixtures thereof, and the like.

Additional structuring/thickening materials which may be used include swelling clays, for example laponite; fatty acids and derivatives hereof and, in particular fatty acid monoglyceride polyglycol ethers; cross-linked polyacrylates such as Carbopol® (polymers available from Goodrich); acrylates and copolymers thereof, e.g. Aqua SF-1 available from Noveon (Cleveland, Ohio), polyvinylpyrrolidone and copolymers thereof; polyethylene imines; salts such as sodium chloride and ammonium sulphate; sucrose esters; gellants; natural gums including alginates, guar, xanthan and polysaccharide derivatives including carboxy methyl cellulose and hydroxypropyl guar; propylene glycols and propylene glycol oleates; glycerol tallowates; and mixtures thereof, mixtures thereof, and the like.

Of the clays particularly preferred are synthetic hectorite (laponite) clay used in conjunction with an electrolyte salt capable of causing the clay to thicken. Suitable electrolytes include alkali and alkaline earth salts such as halides, ammonium salts and sulphates, blends thereof and the like.

Further examples of structurants and thickeners are given in the International Cosmetic Ingredient Dictionary, Fifth Edition, 1993, published by CTFA (The Cosmetic, Toiletry & Fragrance Association), incorporated herein by reference.

Thickeners and/or structurant may comprise from 0.01 up to as high as 65% of composition. Typically, the range is 1-30% by wt.

In one embodiment, compositions of the invention may comprise 0.1-1.5% by wt. of a cationic skin conditioning agent, preferably used in combination with 0.1 to 1% by wt. of a solid, particulate optical modifier, typically of from about 50 to about 300, more preferably 50 to 150 microns on average diameter.

Examples of cationic polymers include cationic cellulosic and cationic polysaccharide

Cationic cellulose is available from Amerchol Corp. (Edison, N.J., USA) in their Polymer JR (trade mark) and LR (trade mark) series of polymers, as salts of hydroxyethyl cellulose reacted with trimethyl ammonium substituted epoxide, referred to in the industry (CTFA) as Polyquarternium 10. Another type of cationic cellulose includes the polymeric quaternary ammonium salts of hydroxyethyl cellulose reacted with lauryl dimethyl ammonium-substituted epoxide, referred to in the industry (CTFA) as Polyquarternium 24. These materials are available from Amerchol Corp. (Edison, N.J., USA) under the tradename Polymer LM-200.

A particularly suitable type of cationic polysaccharide polymer that can be used is a cationic guar gum derivative, such as guar hydroxypropyltrimonium chloride (Commercially available from Rhone-Poulenc in their JAGUAR trademark series). Examples are JAGUAR C13S, which has a low degree of substitution of the cationic groups and high viscosity, JAGUAR C15, having a moderate degree of substitution and a low viscosity, JAGUAR C17 (high degree of substitution, high viscosity), JAGUAR C16, which is a hydroxypropylated cationic guar derivative containing a low level of substituents groups as well as cationic quaternary ammonium groups, and JAGUAR 162 which is a high transparency, medium viscosity guar having a low degree of substitution.

Particularly preferred cationic polymers are JAGUAR C13S, JAGUAR C15, JAGUAR C17 and JAGUAR C16 and JAGUAR C162, especially Jaguar C13S. Other cationic skin feel agents known in the art may be used provided that they are compatible with the inventive formulation.

The optical modifier should be used in effective concentration for exhibiting a specific set of optical properties on skin characterized by a set of Tristimulus Color Values L, a*, and b*; a reflectivity change, and an opacity change, that provides at least a 5% change in at least one of the specific optical properties when said cleansing composition is applied to skin and then rinsed off using the In-vitro Visual Assessment Protocol.

Advantageously, the visual attribute targeted by the optical modifier is selected from skin shine, skin color or skin optical uniformity, and combinations thereof.

Preferably in the case of conferring a skin shine benefit, the change in L value is in the range from about 0 to ±10, the reflectance change in the range from about 0 to ±300%, and the change in opacity in the range from about 0 to ±20% with the proviso that the change in L value, reflectance change and opacity change are not all zero so as to provide noticeable skin shine when said cleansing composition is applied to skin and then rinsed off using the In-vitro Visual Assessment Protocol. For skin shine preferably greater than about 10% (preferably greater than about 20, 30, 40, 50, 60, 70, 80, 90 or 95%) by wt. of the particulate optical modifier is further defined by an exterior surface refractive index, geometry, and specific dimensions wherein:
i) the exterior surface has a refractive index of about 1.8 to 4.0;
ii) the geometry is platy, cylindrical or a blend thereof; and
iii) the specific dimensions are about 10 to 200 um average diameter in the case of a platy particle, or about 10 to 200 um in average length and about 0.5 to 5.0 um in average diameter in the case of a cylindrical particle.

Preferably in the case of conferring a noticeable skin lightening or color change to the skin the change in L value is in the range from about 0 to ±10, the change in the a* value is in the range from about 0 to ±10, a change in the b* value in the range from about 0 to ±10, the change in opacity in the range from about 0 to ±50%, and the reflectance change is within the normal skin reflectivity range of about ±10%, with the proviso that the change in L value, b* and opacity change are not all zero so as to provide noticeable skin lightening or color change when said cleansing composition is applied to skin and then rinsed off using the In-vitro Visual Assessment Protocol. For skin lightening or color change, preferably greater than about 10% (preferably greater than about 20, 30, 40, 50, 60, 70, 80, 90 or 95%) by wt. of the particulate optical modifier is further defined by an exterior surface refractive index, geometry, and specific dimensions wherein:
i) the exterior surface has a refractive index of about 1.3 to 4.0
ii) the geometry is spheroidal, platy or a blend thereof
iii) the specific dimensions are about 1 to 30 um average diameter in the case of a platy particle, or about 0.1 to 1 um in average diameter in the case of a spheroidal particle; and
iv) optionally having fluorescence color, absorption color, interference color or a combination thereof.

In addition, the inventive cleansing composition of the invention may include 0 to 15% by wt. optional ingredients as follows: sequestering agents, such as tetrasodium ethylene diaminetetra acetate (EDTA), EHDP or mixtures in an amount of 0.01 to 1%, preferably 0.01 to 0.05%; and coloring agents, opacifiers and pearlizers such as zinc stearate, magnesium stearate, TiO₂, EGMS (ethylene glycol monostearate) or Lytron 621 (Styrene/Acrylate copolymer) and the like; all of which are useful in enhancing the appearance or cosmetic properties of the product.

The compositions may further comprise antimicrobials such as 2-hydroxy-4,2′,4′ trichlorodiphenylether (DP300); preservatives such as dimethyloldimethylhydantoin (Glydant XL1000), parabens, sorbic acid etc., and the like.

The compositions may also comprise coconut acyl mono- or diethanol amides as suds boosters, and strongly ionizing salts such as sodium chloride and sodium sulfate may also be used to advantage.

Antioxidants such as, for example, butylated hydroxytoluene (BHT) and the like may be used advantageously in amounts of about 0.01% or higher if appropriate.

Moisturizers that also are humectants such as polyhydric alcohols, e.g. glycerine and propylene glycol, and the like; and polyols such as the polyethylene glycols listed below and the like may be used.

| | |
|---|---|
| Polyox WSR-205 | PEG 14M, |
| Polyox WSR-N-60K | PEG 45M, or |
| Polyox WSR-N-750 | PEG 7M. |

Hydrophobic and/or hydrophilic emollients (i.e. humectants) mentioned above may be used. Preferably, hydrophilic emollients are used in excess of hydrophobic emollients in the inventive cleansing composition. Most preferably one or more hydrophilic emollients are used alone. Hydrophilic emollients are preferably present in a concentration greater than about 0.01% by weight, more preferably greater than about 0.5% by weight. Preferably the inventive composition contains less than about 10, 5, 3, 2, 1, 0.7, 0.5, 0.3, 0.2, 0.1, 0.05 or 0.01% by wt. of a hydrophobic emollient.

The term “emollient” is defined as a substance which softens or improves the elasticity, appearance, and youthfulness of the skin (stratum corneum) by either increasing its water content, adding, or replacing lipids and other skin nutrients; or both, and keeps it soft by retarding the decrease of its water content.

### In-vitro Visual Assessment Protocol (Porcine/Pig Skin Assay):

Take a piece of black porcine skin (L=40±3) with the dimensions of 5.0 cm×10 cm and mount it on a black background paper card. Initial measurements are made of the untreated skin. The mounted skin is then washed 1 to 2 minutes with “normal” rubbing with the composition to be tested and rinsed for about ½ minute with 45° C. tap water. After 2 hours of drying at 25° C., the final measurements for color L, a*, b*; reflectivity and opacity are made.

### Color Measurements:

The initial and final color measurements of porcine or in-vivo human skin are made with a Hunter Lab spectracolormeter using a 0° light source and 45° detector geometry. The spectracolormeter is calibrated with the appropriate black and white standards. Measurements are made before and after the wash treatment. Three measurements are made each time and averaged. The values obtained are L, a*, b*, which come from the La*b* color space representation.

### Opacity Determination:

The opacity of the skin treated by the cleansing composition can be derived from the hunter Lab color measurements. The opacity contrast value is calculated from the delta L (which is the change in whiteness after deposition) divided by 60 (which is the difference in L value of the skin and a pure white color).

### Reflectance or Radiance Determination:

The initial and final reflectance/radiance measurement of porcine or in-vivo human skin is made with a glossmeter before and after treatment with the cleansing composition. The glossmeter is first set with both the detector and light source at 850 from normal. Then the glossmeter is calibrated with an appropriate reflection standard. Measurements are made before and after application and rinsing off of the cleansing composition and the percent difference calculated.

Since a noticeable change in the skin when treated with the inventive composition may provide only scattered areas of skin appearance enhancement (such as point sparkle, glitter, etc.) instead of a continuous change over a wider expanse of the skin better suited to instrumental analysis using the glossmeter etc.; for the purposes of defining the level of skin appearance change required to be shown for the inventive composition, a “yes” result in either the Tile method, the Consumer method, the Hand wash (lab) method, or any combination thereof is to be considered equivalent to at least a 5% change in reflectivity when the inventive cleansing composition is applied to skin and then rinsed off using the In-vitro Visual Assessment Protocol.

Cone and Plate Viscosity Measurement

### Scope:

This method covers the measurement of the viscosity of the isotropic phase cleansing composition.

### Apparatus:

Brookfield Cone and Plate DV-II+ Viscometer;
Spindle S41;

### Procedure:

1. Turn on Water Bath attached to the sample cup of the viscometer. Make sure that it is set for 25° C. Allow temperature readout to stabilize at 25° C. before proceeding.
2. With the power to the viscometer off, remove the spindle (S41) by turning counterclockwise.
3. Turn the power on and press any key as requested to autozero the viscometer.
4. When the autozero function is complete, replace the spindle (turning clockwise) and press any key.
5. Attach the sample cup. Using the up/down arrow keys, slowly change the speed to 10 rpm and press the SET SPEED key. Use the SELECT DISPLAY key so that the display is in % mode.
6. Turn the motor on. If the display jumps to 0.4% or higher or will not settle to 0±0.1%, turn the adjustment ring clockwise until it does.
7. Rotate the adjustment ring counterclockwise until the reading is fluctuating between 0.0 and 1.0%. The fluctuation must occur approximately every 6 seconds.
8. Turn the adjustment ring clockwise exactly the width of one division from the setting reached in step 7.
9. Turn the motor off. Using the up/down arrow keys, slowly change the speed to 0.5 rpm and press the SET SPEED key. Use the SELECT DISPLAY so that the display is in cP.
10. Place 2±0.1 g of product to be measured into the sample cup. Attach the cup to the viscometer.
11. Allow the product to remain in the cup with the motor OFF for 2 minutes.
12. Turn the motor ON and allow the spindle to turn for 2 minutes before noting the reading on the display.

### EXAMPLES

### Example 1

### Effect of Perfume Compounds on Formulation Rheology

Perfume compounds that would be expected to have the most significant effect in raising formulation viscosity of low active formulation: molecular volume >400 A³, polarity >1 MPa^{1/2}. These components would individually (or, if part of a product, as for example >50% of the mixture) be expected to raise viscosity of low surfactant, perfume free composition having viscosity of <1 Pa·s to viscosity of >25 Pa·s to 500 Pa·s. The following are examples:

EXAMPLE 1

| | | molecule | |
|---|---|---|---|
| chemical name | CAS | volume (A³) | Polarity (MPa^{1/2}) |
| Polysantol | 0107898-54-4 | 958.27 | 3.15 |
| Alpha Hexylcinnamaldehyde | 101-86-0 | 663.92 | 2.23 |
| phenyl ethyl acetate(2-phenyl ethyl ace | 103-45-7 | 711.03 | 3.12 |
| phenoxyethyl isobutyrate(2-phenoxyethy | 103-60-6 | 965.99 | 16.91 |
| Undecanoic y-lactone | 104-67-6 | 1171.51 | 6.51 |
| Exaltolide | 106-02-5 | 943.26 | 4.62 |
| Citronellol | 106-22-9 | 491.01 | 2.9 |
| Melonal | 106-72-9 | 566.84 | 2.98 |
| Aldehyde MNA | 110-41-8 | 900.80 | 2.16 |
| Aldehyde MNA | 110-41-8 | 900.80 | 2.16 |
| Folione (Methyl 2-octynoate) | 111-12-6 | 664.93 | 3.29 |
| Habanolide | 111879-80-2 | 860.12 | 4.68 |
| Thujone (Alpha Beta mixture) | 1125-12-8 | 537.72 | 4.10 |
| linalyl acetate | 115-95-7 | 956.35 | 2.35 |
| Linalyl Formate | 115-99-1 | 744.51 | 3.08 |
| Phenyl Salicylate | 118-55-8 | 603.61 | 14.27 |
| methyl-(methylenedioxyphenyl)-propanal | 1205-17-0 | 698.38 | 4.98 |
| Ambrettolide | 123-69-3 | 941.44 | 4.39 |
| Octanal | 124-13-0 | 604.78 | 3.25 |
| Linalyl Benzoate | 126-64-7 | 1018.97 | 7.10 |
| Butylated hydroxytoluene | 128-37-0 | 728.84 | 4.12 |
| Methyl Ionone (alpha/beta mix) | 1322-70-9 | 677.13 | 3.45 |
| Iralia | 1335-46-2 | 843.32 | 3.61 |
| Mayol | 13828-37-0 | 558.76 | 2.85 |
| Aldehyde Supra | 143-14-6 | 681.31 | 2.44 |
| Linalyl propionate | 144-39-8 | 1001.65 | 2.45 |
| Exaltenone | 14595-54-1 | 657.51 | 2.51 |
| Cyclomethylene citronellol | 15760-18-6 | 535.46 | 2.88 |
| Trifernal | 16251-77-7 | 407.51 | 3.31 |
| Dihydrolinalool | 18479-51-1 | 756.00 | 4.18 |
| Aldehyde MOA | 19009-56-4 | 755.94 | 2.33 |
| Methyl Jasmonate | 20073-13-6 | 1164.67 | 3.86 |
| Stemone | 22457-23-4 | 466.18 | 5.01 |
| cis-6-nonenal | 2277-19-2 | 767.86 | 2.90 |
| Cis-6-nonenal | 2277-19-2 | 767.86 | 2.90 |
| Beta Damascenone | 23696-85-7 | 672.83 | 3.92 |
| Damascone Beta | 23726-91-2 | 775.63 | 3.86 |
| Damarose alpha | 24720-09-0 | 719.10 | 3.68 |
| cis-3-hexenyl benzoate | 25152-85-6 | 1034.59 | 6.62 |
| caproic acid cis-3-hexen-1-yl ester | 31501-11-8 | 1360.49 | 2.51 |
| hydroxyisohexyl 3-cyclohexene carboxal | 31906-04-4 | 694.32 | 4.35 |
| cis-3-hexenyl acetate | 3681-71-8 | 603.86 | 3.08 |
| Cyclopidene | 40203-73-4 | 544.96 | 10.29 |
| Ambrinol | 41199-19-3 | 656.82 | 3.63 |
| Plicatone | 41724-19-0 | 577.29 | 3.85 |
| Rhubofix | 41816-03-9 | 615.90 | 2.59 |
| Methyl atratate | 4707-47-5 | 641.87 | 9.16 |
| Delfone | 4819-67-4 | 636.39 | 3.79 |
| Aldehyde mandarine 10% CITR | 4826-62-4 | 761.95 | 2.26 |
| Dihidromyrcenol | 53219-21-9 | 672.11 | 4.23 |
| Muscone | 541-91-3 | 963.47 | 2.29 |
| Civettone | 542-46-1 | 936.29 | 2.21 |
| Phenylhexanol | 55066-48-3 | 633.25 | 2.89 |
| Dynascone | 56973-85-4 | 738.33 | 4.09 |
| Oxane | 59323-76-1 | 607.73 | 3.47 |
| Hexyl Salicylate | 6259-76-3 | 1251.72 | 7.41 |
| Florol | 63500-71-0 | 560.12 | 5.17 |
| Veloutone | 65443-14-3 | 895.14 | 2.94 |
| Isopropyl methyl-2-butyrate | 66576-71-4 | 531.91 | 2.91 |
| Florex | 69486-14-2 | 595.08 | 7.70 |
| gamma-decalactone | 706-14-9 | 665.41 | 7.09 |
| Cedroxyde | 71735-79-0 | 740.84 | 2.74 |
| Ethyl 2 methyl butyrate | 7452-79-1 | 447.71 | 3.20 |
| alpha-methyl ionone | 7779-30-8 | 803.54 | 3.61 |
| Irone alpha | 79-69-6 | 705.60 | 3.34 |
| Cetone V | 79-78-7 | 973.71 | 3.30 |
| Isopentyrate | 80118-06-5 | 727.28 | 2.66 |
| Terpinyl acetate | 80-26-2 | 701.84 | 5.88 |
| Terpinyl acetate | 80-26-2 | 701.84 | 6.25 |
| Romascone | 81752-87-6 | 561.52 | 2.57 |
| Muscenone | 82356-51-2 | 855.60 | 2.33 |
| Scentenal | 86803-90-9 | 693.35 | 3.22 |
| Eugenyl Acetate | 93-28-7 | 963.03 | 4.37 |
| Alpha-methylbenzyl acetate | 93-92-5 | 572.86 | 3.90 |
| Doremox | 94201-73-7 | 422.35 | 2.60 |
| lilial | 80-54-6 | 637.00 | 2.27 |
| dihydromyrcenol | 18479-58-8 | 523.35 | 4.25 |
| linalool | 78-70-6 | 528.00 | 4.18 |
| benzyl salycilate | 118-58-1 | 490.00 | 8.30 |
| ethylene brassylate | 105-95-3 | 905.63 | 6.43 |
| 4-isopropylbenzaldehyde | 122-03-2 | 432.621 | 5 |

### Example 2

### Effect of Perfume Compounds on Formulation Rheology

Perfume compounds that has the intermediate effect in raising formulation viscosity of low active formulation: molecular volume <400 A³, polarity >1 MPa¹². These components would individually (or, if present for example, as >50% of mixture) be expected to raise viscosity of low surfactant, perfume free composition having a viscosity of <1 Pa·s to >1 to 40 Pa·s. The following are examples:

| | | Molecule | Polarity |
|---|---|---|---|
| chemical name | CAS | Volume (A³) | (MPa^{1/2}) |
| 2-propanone | 67-64-1 | 142.04 | 10.4 |
| Acetaldehyde | 75-07-0 | 157.30 | 4.3 |
| Butanol | 71-36-3 | 170.10 | 5.7 |
| 2-furaldehyde | 98-01-1 | 176.96 | 14.86 |
| 2-butanone | 78-93-3 | 181.44 | 9 |
| Butyraldehyde | 123-72-8 | 182.07 | 5.28 |
| 2,3-butanedione | 431-03-8 | 196.71 | 13.4 |
| Valeraldehyde | 110-62-3 | 201.68 | 4.46 |
| Benzaldehyde | 100-52-7 | 208.79 | 7.38 |
| butanoic acid | 107-92-6 | 215.47 | 4.14 |
| hexyl alcohol | 111-27-3 | 222.18 | 3.9 |
| Indole | 120-72-9 | 234.78 | 7.75 |
| hex-trans-2-enal | 6728-26-3 | 254.188 | 4.1 |
| Coumarin | 91-64-5 | 254.63 | 18.96 |
| Hexa-trans,trans,-2,4-dienal | 142-83-6 | 255.15 | 4.5 |
| benzyl alcohol | 100-51-6 | 258.89 | 6.29 |
| 2-heptanone | 110-43-0 | 261.252 | 6 |
| Ethylbutanoate | 105-54-4 | 264.04 | 4.1 |
| 2-methyl phenol | 95-48-7 | 270.06 | 5 |
| p-cresol | 106-44-5 | 272.34 | 5 |
| Cinnamaldehyde | 104-55-2 | 272.44 | 3.95 |
| phenyl ethyl alcohol (PEA) | 60-12-8 | 293 | 2.9 |
| 2,5 dimethylpyrazine | 123-32-0 | 301.50 | 9.49 |
| 2-buten-1-ol-3-methyl | 556-82-1 | 309.23 | 7.15 |
| p-anisaldehyde | 123-11-5 | 311.74 | 6.8 |
| Methyl anthranilate extra | 134-20-3 | 320.23 | 10.30 |
| hexyl acetate | 142-92-7 | 328 | 2.9 |
| Vanillin | 121-33-5 | 330.62 | 9.9 |
| Heliotropine | 120-57-0 | 334.46 | 8.69 |
| Dimethyl allyl acetate(2-buten- | 1191-16-8 | 339.83 | 3.49 |
| 1-ol 3-me | | | |
| 2-ethylpyrazine | 13925-00-3 | 342.33 | 8.3 |
| 2-ethyl-3-methoxy-pyrazine | 25680-58-4 | 343.90 | 8.3 |
| Methyl heptenone pure | 110-93-0 | 353.20 | 5.63 |
| Jasmone Cis | 488-10-8 | 357.04 | 7.33 |

### Example 3

Effect of perfume compounds on formulation viscosity of low active formulation without any additional salt other than those brought in by surfactant. Formulation contains 10% SLES.1EO/2% CAPB.

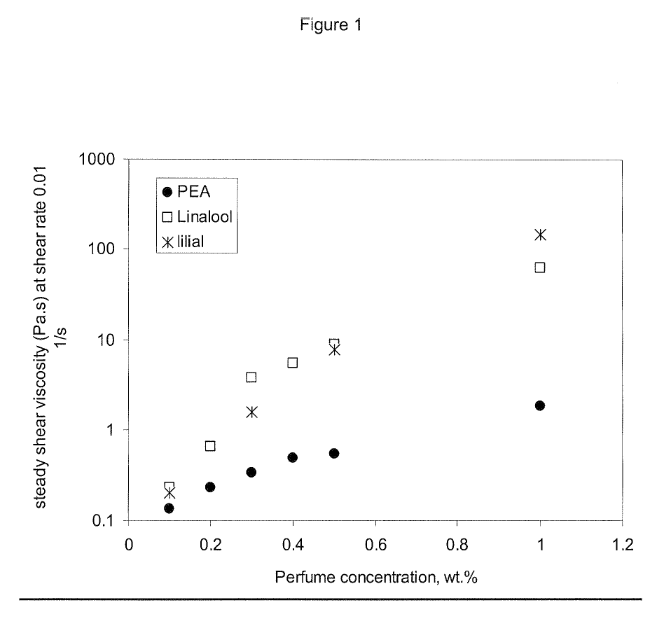

Results can be seen in FIG. 1

### Example 4

Among compounds listed in Example 1: the following compounds showed a significantly thickening effect for the low active base (8% SLES/4% CAPB), Concentration for perfume compound is 1%.

| | | Zero shear |
|---|---|---|
| | CAS | viscosity (Pa · s) |
| Base | | 0.06 |
| Linalool | 78-70-6 | 57.06 |
| Benzyl salicylate | 118-58-1 | 40.43 |
| Lilial | 80-54-6 | 146.1 |
| Citronellol | 106-22-9 | 445.63 |
| Undecanoic y-lactone | 104-67-6 | 108.69 |
| Dihydromyroenol | 53219-21-9 | 96.38 |
| Ethylene brassylate | 105-95-3 | 86.99 |
| Alpha hexylcinnamic aldehyde | 101-86-0 | 83.52 |

From this Example 4, it can be seen that those components having a molecular volume >400 A³ and polarity >1 MPa^{1/2} all raised zero shear viscosity from <1 Pa·s to at least 40 Pa·s and approaching 500 Pa·s.

### Example 5

More Examples of compounds listed in Example 1 that showed a significantly thickening effect for the low active base (8% SLES/4% CAPB). Concentration for perfume compound is 1%.

| | | Zero shear |
|---|---|---|
| | CAS | viscosity (Pa · s) |
| Base | | 0.07 |
| Nonadienal | 557-48-2 | >60 |
| Phenyl hexanol | 55066-48-3 | >60 |
| Geranyl acetone | 689-67-8 | >60 |
| Gamma decalactone | 706-14-9 | >60 |
| Felvinone | 68259-33-6 | >60 |
| Calyxol | 59151-19-8 | >60 |

These are additional examples showing components of molecular volume >400 A³ and polarity >1 MPa^{1/2} raising zero shear viscosity from below 1 Pa·s to >60.

Comparative: the following compounds listed in Example 1 only showed an intermediate thickening effect for the low active base (8% SLES/4% CAPB). Concentration for perfume compound is 1% if not otherwise stated. These compounds are specifically excluded from the first group of the invention (although they could be included in the second group of Example 2, based on their affect).

| | | Zero shear |
|---|---|---|
| | CAS | viscosity (Pa · s) |
| Base | | 0.01 |
| 0.5% muscone | 541-91-3 | 15.03 |
| Methyl jasmonate | 1211-29-6 | 15.41 |
| 0.5% methyl ionone (alpha/beta mix) | 1322-70-9 | 15.53 |
| Alpha methyl benzyl acetate | 93-92-5 | >2 |
| Tepinyl acetate | 80-26-2 | >2 |
| Musk methyl ketone (Traseolide) | 68140-48-7 | >2 |

Comparative: the following compounds listed in Table 1 will not thicken the low active base (8% SLES/4% CAPB). The low active base remains water-thin. Concentration for perfume compound is 1% if not otherwise stated. These compounds are specifically excluded from first group, and would not fall within effects of second group either.

| | | Zero shear |
|---|---|---|
| | CAS | viscosity (Pa · s) |
| Base | | 0.01 |
| Peach nitril (Frutonile) | 69300-15-8 | <1 |
| Oxane | 59323-76-1 | <1 |
| Hexyl salicylate | 6259-76-3 | <1 |
| Ironyl acetate | 58430-94-7 | <1 |
| Methyl ionone (alpha/beta mix) | 1322-70-9 | <1 |
| Muscone | 541-91-3 | <1 |

### Example 6

The following compounds showed an intermediate thickening effect for the low active base (8% SLES/4% CAPB). Concentration for perfume compound is 1%.

| | | Zero shear |
|---|---|---|
| | CAS | viscosity (Pa · s) |
| Base | | 0.01 |
| Hexyl alcohol | 111-27-3 | 33.77 |
| Cinnamic aldehyde | 104-55-2 | 19.13 |
| Jasmine cis | 488-10-8 | 17.41 |
| Coumarin | 91-64-5 | 15.87 |
| Benzyl alcohol | 100-51-6 | 14.93 |
| Hexyl acetate | 142-92-7 | 15.21 |
| PEA | 60-12-8 | 2.86 |

These are examples having components of V<400 A³ and polarity of >1 MPa^{1/2} raising viscosity in low surfactant formulations from <1 Pa·s to range of >1 to 40 Pa·s.

### Example 7

Perfume mixes with different composition of perfume compounds are tested for their effect on rheology of low active base (8% SLES/4% CAPB). Concentration for perfume mix in the base is 1%. Each mix has different composition of linalool (thickening perfume compound), lilial (thickening perfume compound), limonene (perfume compound that has no thickening effect) and PEA (perfume compound that has intermediate thickening effect) at different composition as listed.

| | | | | | | Zero shear |
|---|---|---|---|---|---|---|
| | Perfume | Linalool | Lilial | Limonene | PEA | viscosity |
| Example | mix | (%) | (%) | (%) | (%) | (Pa · s) |
| Central | Base | | | | | 0.01 |
| 7a | Mix 1 | 40 | 40 | 10 | 10 | 54.05 |
| 7b | Mix 2 | 30 | 30 | 20 | 20 | 26.19 |
| 7c | Mix 3 | 20 | 20 | 30 | 30 | 18.02 |
| 7d | Mix 4 | 5 | 5 | 85 | 5 | <1 |

This example shows that when >50%, preferably >60% of component of any mixture comprises components of a particular group (e.g., molecular volume >400 A³ and polarity >1 MPa^{1/2}), then they have the same effect as any individual component in that group in raising viscosity. Thus, for example, if individual perfume components having V>400 A³ and polarity >1 MPa^{1/2} will raise viscosity of low surfactant compositions from less than 1 Pa·s (prior to perfume addition) to >25 to 500 Pa·s, as seen above, a perfume mix with two components of that group comprising >50% of the mix also will raise viscosity by that amount (See 7a and 7b).

1. A method of enhancing viscosity of liquid composition comprising
15% by wt. or less of a surfactant selected from the group consisting of anionic, nonionic, amphoteric/zwitterionic, cationic surfactant and mixtures thereof;
substantially no perfume, and zero shear viscosity of <1 Pa·s; wherein said method comprises adding individual perfume component having molecular volume (V)>400 A³ and polarity >1 MPa^{1/2} or adding mixture of components, wherein components having noted volume and polarity comprise >50% of the perfume mixture.

2. A composition according to claim 1, comprising 0.1 to 65% thickener and/or structurants;

3. A composition according to claim 1 comprising 0.1 to 1.5% by wt. cationic polymer and 0 to 3% by wt. solid particulate modifier.

4. A method according to claim 1 comprising <1-12% by wt. surfactant.

5. A method according to claim 1 wherein addition of individual perfume or mixtures raises viscosity to level of >25 to 500 Pa·s.

6. A method of enhancing viscosity of liquid composition comprising 15% by wt. or less of a surfactant selected from the group consisting of anionic, nonionic, amphoteric/zwitterionic, cationic surfactant and mixtures thereof; substantially no perfume and zero shear viscosity <1 Pa·s, wherein said method comprises adding individual perfume component having molecular volume (V)<400 A³ and polarity >1 MPa^{1/2} or mixtures of components wherein components having noted volume and value or polarity comprise >50% of the perfume mixture.

7. A method according to claim 6 comprising 1-12% by wt. surfactant.

8. A method according to claim 6 wherein addition of individual perfumes or mixtures raised viscosity to a level of >1 to 40 Pa·s.
